(19) United States
(12) Patent Application Publication
(10) Pub. No.: US 2022/0289420 A1
(43) Pub. Date: Sep. 15, 2022

(54) LABELER WITH PUSHER ASSEMBLY

(71) Applicant: MULTIVAC MARKING & INSPECTION GMBH & CO. KG, Enger (DE)

(72) Inventor: Steffen FELLHOELTER, Herford (DE)

(73) Assignee: MULTIVAC MARKING & INSPECTION GMBH & CO. KG, Enger (DE)

(21) Appl. No.: 17/689,715

(22) Filed: Mar. 8, 2022

(30) Foreign Application Priority Data
Mar. 9, 2021 (DE) 102021105699.3

(51) Int. Cl. B65C 9/36; B65C 1/02

(52) U.S. Cl. CPC B65C 9/36; B65C 1/021

(57) ABSTRACT

A labeler comprises at least one pusher assembly for pressing labels onto an article web, the pusher assembly being mounted to be adjustable in height. The pusher assembly comprises a base plate, at least one pin cartridge connected to the base plate, and several press-on pins that are received by the pin cartridge and that are mounted at the pin cartridge in a slidable manner between a respective extended position and a retracted position. The press-on pins are each formed as integrally manufactured injection molded parts.

### CROSS-REFERENCE TO RELATED APPLICATIONS

This application claims foreign priority benefits under 35 U.S.C. § 119(a)-(d) to German patent application number DE 10 2021 105 699.3, filed Mar. 9, 2021, which is incorporated by reference in its entirety.

### TECHNICAL FIELD

The present disclosure relates to a labeler.

### BACKGROUND

A labeler for applying labels in rows on a film web is known from EP 2 666 728 B1. The labeler is arranged at a deep-drawing packaging machine downstream of a sealing station. The labeler comprises substantially a label dispenser as well as a transfer device to which labels are fed successively in a row by the label dispenser. The transfer device is configured to move the labels it has picked up to a predetermined position above an article web provided therebeneath, comprising several sealed packs positioned next to one another, in order to subsequently press the labels onto the top film of the respective packs. For this purpose, the transfer device comprises a plurality of pin pusher plates which are mounted to be adjustable in height by a lifting device for pressing the labels firmly onto the top film.

DE 10 2006 047 488 A1 discloses a labeler with an applicator unit that comprises several press-on dies for applying labels to a film web. The press-on dies are arranged individually in sleeves so that they can be moved in and out.

EP 3 495 280 A1 discloses a pusher assembly, where the respective press-on elements are attached to a base plate of the pusher assembly by way of a cartridge module configured to receive them. The press-on elements are each manufactured of three individual parts, namely a peg made of polyoxymethylene (POM), a guide pin made of a precious metal, e.g., an alloy made of X5CrNi18-10, and a press-on pin likewise made of polyoxymethylene (POM). These three components are placed in an assembly device and are pressed together. However, assembly errors inevitably occur with such three-part press-on pins pressed in this manner. For example, these press-on pins can be assembled incorrectly if the pressing forces acting upon them vary during the pressing process of the three individual parts. As a result, reworking may be necessary later, which leads to downtimes of the packaging machine.

What adds to this is that, due to its rigid configuration, a guide pin made of stainless steel additionally transmits the transverse forces exerted thereupon during a labeling process almost one-to-one to other components of the cartridge module which can be damaged or at least loosened as a result. For example, a clamping strip that attaches the guide pin to the cartridge module can be damaged or dislodged from its attachment by lateral forces applied to it. This problem occurs above all when labels are to be applied to an uneven packaging surface, as a result of which the rigidly configured guide pins tend to turn sideways and press against the clamping strips.

### SUMMARY

It is an object of the disclosure to improve a labeler of the type described above in terms to the drawbacks associated with prior art.

The labeler according to the disclosure comprises at least one pusher assembly, which is mounted to be adjustable in height, for pressing labels onto an article web. The pusher assembly comprises a base plate, at least one pin cartridge connected to the base plate, and a several press-on pins received in the pin cartridge and mounted on the pin cartridge in a slidable manner between a respective extended position and a retracted position. According to the disclosure, the press-on pins are each configured as injection molded parts that are manufactured integrally.

Due to the press-on pins each being manufactured integrally by injection molding, the above-mentioned production-related drawbacks described in the context of the three-part configuration of known press-on pins can be prevented. Above all, different types of plastic materials can be used for the integrally formed injection molded pins, so that the injection molding material can be easily adapted to the respective press-on pins with regard to different requirements, for example, with regard to a desired pressing force.

According to a preferred variant, the press-on pins comprise a guide pin manufactured at least in sections from a polyamide (PA), in particular from a polycaprolactam (PA6) or from nylon (PA66). A guide pin that is injection-molded from such plastic material provides the significant advantage that it can bend resiliently in response to transverse forces absorbed by it during a labeling process such that adjacent other components, for example, a clamping strip that clamps the guide pin at the lower end of the pin cartridge, are not particularly loaded, if at all. As a result, the clamping strip is neither damaged nor loosened from its attachment, so that the downtime of the labeler is reduced overall.

The press-on pins preferably comprise at one end of the guide pin a peg that can be received by way of the pin cartridge and a press member at the other end of the guide pin, wherein the guide pin, the peg, and the press member are manufactured integrally. This integral configuration of the respective press-on pins noticeably reduces their manufacturing costs.

It has been found that press-on pins that are manufactured substantially entirely from polycaprolactam (PA6) or from nylon (PA66) are particularly advantageous for use in the labeler. Above all, these press-on pins are inexpensive to manufacture.

The specific selection of the plastic material for the integral manufacture of the respective press-on pins is based on a consideration of several factors. Firstly, the flexural strength must be taken into account, i.e., the magnitude that indicates how high the maximum bending stress may be during labeling without the press-on pin being damaged while it applies the desired press-on force despite its potential bending.

When it comes to flexural strength it is important to consider how much the press-on pins are allowed to yield to three-dimensional surface contours in order to ensure a desired surface press-on force. In order for the respective press-on pins to be able to bend sufficiently at interfering contours, but not to yield too much, and for labels to be reliably attached at a predetermined position, the flexural strength of the press-on pins must be neither too low nor too high. If the flexural strength were very low, for example, with a press-on pin made of polyethylene (PE-HD), the press-on pin would tend to bend quickly, which means that the press-on force required for labeling can no longer be obtained. However, if the flexural strength is very high, such as with a press-on pin made of PA66 GF25 (25% glass fiber reinforced nylon), then the press-on pin would only bend very slightly at an interference contour, so that a similar negative effect would arise as with the known press-on pins made of stainless steel. Such rigid press-on pins can even damage the product to be labeled or the label cannot be pressed onto the production surface over the entire surface. However, if a high press-on force is required in a specific case, the PA66 GF25 material can be the suitable material for the press-on pins.

In terms of flexural strength, unreinforced detectable polyamide PA66 DET and/or impact-resistant polyoxymethylene (POM-HI) are in the middle range among the plastic materials mentioned above. These two materials do not bend under low lateral forces and therefore provide sufficient stability for the labels to be pressed on reliably. Should unforeseen unevenness on the product lead to higher transverse forces, then these materials can deform sufficiently resiliently.

Another important criterion to consider when selecting the material is the elongation at break. The elongation at break indicates the percentage elongation at which the material fractures. It may be the case there that, for example, polyamides reinforced on a carbon fiber and/or glass fiber basis, such as PA6 (Perlon) reinforced in this manner or PA66 (Nylon) reinforced in this manner, are not the suitable plastic materials for manufacturing the press-on pins. Such press-on pins tend to facture at very low elongation and are therefore rather unsuitable for uneven packaging. However, this material may be the suitable choice for special cases in which a high press-on force and less flexibility are required.

With 400% elongation at break, PE-HD provides a very high level of flexibility, but it is not shortlisted for the manufacture of the press-on pins due to the low flexural strength and the low heat resistance. The heat resistance, i.e., the maximum temperature that the plastic material must withstand at least for a short period of time, is relevant when selecting the preferred material already for the reason that the labeler, in particular the pusher assemblies formed thereon, are exposed to high temperatures at least for a short period of time during cleaning intervals. All the plastic materials discussed above provide sufficient heat resistance.

In view of the previous evaluation of potential materials, it turned out that plastic material PA6 or PA66, possibly PA66 DET (detectable), which, in addition to its good technical properties also even has FDA approval, is suitable for the labeler according to the disclosure and very advantageous for the manufacture of the press-on pins. The possibility that these materials can be detected is also a very welcome property in the field of packaging technology

It is conceivable that at least the guide pin of the press-on pins is configured to be reinforced with glass fibers and/or carbon fibers in some sections. With this material reinforcement, high press-on forces can be obtained for the labeling process.

According to an embodiment of the disclosure, at least the guide pin of the press-on pins comprises thermoplastic polyurethane. A desired resilience for the guide pin can thus be set.

The pin cartridge preferably comprises at least one clamping strip attached thereto for holding the press-on pins at the pin cartridge. The clamping strip can be clipped to the pin cartridge. The clamping strip can possibly be easily dismantled to replace any damaged press-on pins.

In addition to its attachment function, it is conceivable that the clamping strip also has a guiding function for several press-on pins. For this purpose, the clamping strip can comprise several claw-like receptacles for the press-on pins, i.e., their guide pins, on which the press-on pins are mounted in a slidable manner.

It is possible for the clamping strip to be configured to absorb transverse forces caused during a labeling process by way of bent press-on pins that come into contact with the clamping strip. Due to the fact that the respective press-on pins can bend resiliently due to their material composition when they strike an uneven packaging surface, i.e., already bend as such without striking the cartridge module, the lateral forces acting upon the clamping strip, if any, will be so small that that the clamping strip is no longer damaged or loosened.

The press-on pins each preferably have a weight of 0.3 g to 0.5 g, in particular 0.4 g. Compared to a known three-part press-on pin that weighs approx. 1.4 g, this results in a weight advantage of 1 g. With an average pin pusher plate set having 500 pins, this results in a reduction of 500 g of moving mass against gravity. This weight reduction means that the performance of the cross-web labeler can be increased significantly.

The unit costs of the injection-molded press-on pin manufactured integrally according to the disclosure are at around 5 to 6 cents. The assembly costs, i.e., the costs for assembling multi-part press-on pins, are completely eliminated for a single-part press-on pin according to the disclosure, which contributes significantly to the reduction in manufacturing costs. A three-part press-on pin, for example, as described in the introduction to the description, currently costs 20 cents. Of this, 8 cents go to assembly. The material costs are 12 cents. Consequently, a price saving of 14 to 15 cents for every press-on pin arises for the press-on pins according to the disclosure.

The disclosure further relates to the use of several press-on pins, each of which is manufactured as a single-part injection molded member and/or which comprises a guide pin that is manufactured at least in sections from polyamide (PA), in particular a polycaprolactam (PA6) or nylon (PA66), at a pusher assembly of a labeler for pressing labels onto an article web.

### BRIEF DESCRIPTION OF THE DRAWINGS

Embodiments of the disclosure are explained in more detail with reference to the following figures, where:

FIG. 1 shows a deep-drawing packaging machine with a labeler according to the disclosure;

FIG. 2 shows an enlarged view of the labeler in a starting position;

FIG. 3 shows a view like in FIG. 2 in a labeling position;

FIG. 4 shows a pusher assembly of the labeler in an isolated view;

FIG. 5 shows an exploded view of the pusher assembly shown in FIG. 4;

FIG. 6 shows a tray sealer at which a labeler according to the disclosure can be used;

FIG. 7 shows a press-on pin according to the disclosure in an isolated view; and

FIG. 8 shows a schematic representation of bendable press-on pins.

Same components are provided with the same reference signs throughout the figures.

### DETAILED DESCRIPTION

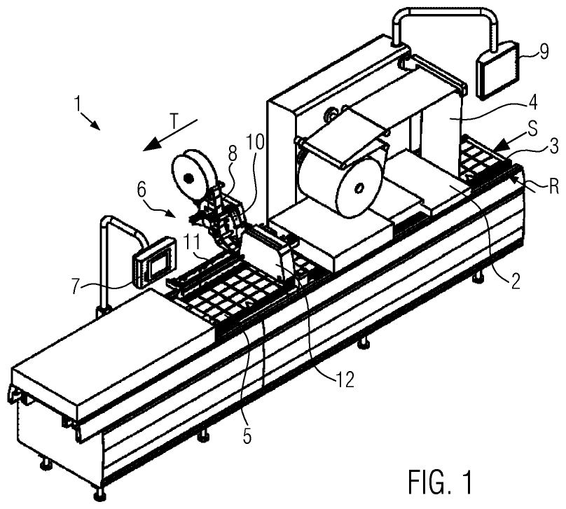

FIG. 1 shows a portion of a deep-drawing packaging machine 1 with a sealing station 2 into which a base film 3 and a top film 4 are fed for producing packs 5. For example, twelve packs 5, divided into four lanes S and three rows R, are sealed in one work cycle in sealing station 2. A labeler 6 with a control device 7 is disposed in direction of transport T downstream of sealing station 2 for applying labels 8 at twelve packs 5 per work cycle from above onto top film 4. The control device 7 of labeler 6 can also be integrated into a control device 9 of deep-drawing packaging machine 1. Labeler 6 comprises a label dispenser 10, a positioning device 11 that can be adjusted in direction of transport T, and a transfer device 12.

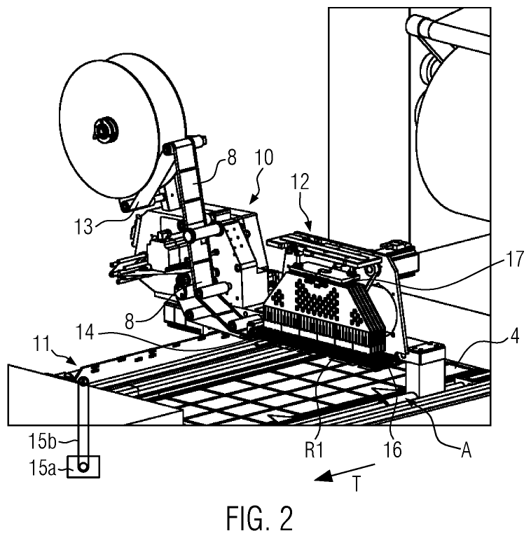

FIG. 2 shows label dispenser 10 with a carrier strip 13 for labels 8, wherein labels 8 are detached from carrier strip 13 by way of a dispenser edge 14 and transferred to transfer device 12. For the sake of clarity, transfer device 12 is shown without an enclosure. The non-adhesive upper side of labels 8 can be held on transport belt 16 by way of a negative pressure generated within the enclosure using fans, while a first row R1 of labels 8 having the number of lanes S is picked up by transfer device 12. During this phase, a lifting device 17 of transfer device 12 is in a pick-up position.

In order to apply row R1 of labels 8 downwardly onto top film 4, positioning device 11 moves label dispenser 10 with transfer device 12 in or opposite direction of transport T to the position in which row R1 of labels 8 is applied from above onto top film 4. Transfer device 12 is then disposed above an article web A. Positioning device 11 is driven by a schematically illustrated servo motor 15a and a toothed belt drive 15b. Transfer device 12, however, can also be positioned above article web A of packs 5 while first row R1 of labels 8 is picked up.

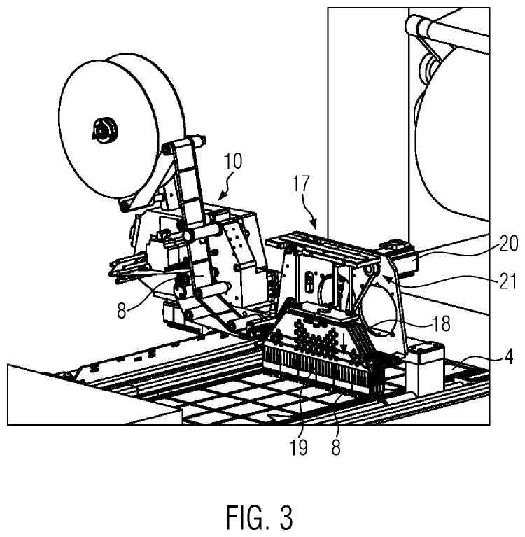

FIG. 3 shows the phase in which lifting device 17, which comprises several pusher assemblies 18 with spring-loaded press-on pins 19, has been moved downwardly to such an extent that labels 8 are lifted off transport belts 16 by press-on pins 19 and pressed onto top film 4. Pusher assemblies 18 are moved by way of a servo motor 20 and a belt drive 21 to the target position. The target position can be set by the operator such that an optimal and predefined press-on force is generated for spring-loaded press-on pins 19 pressing onto labels 8.

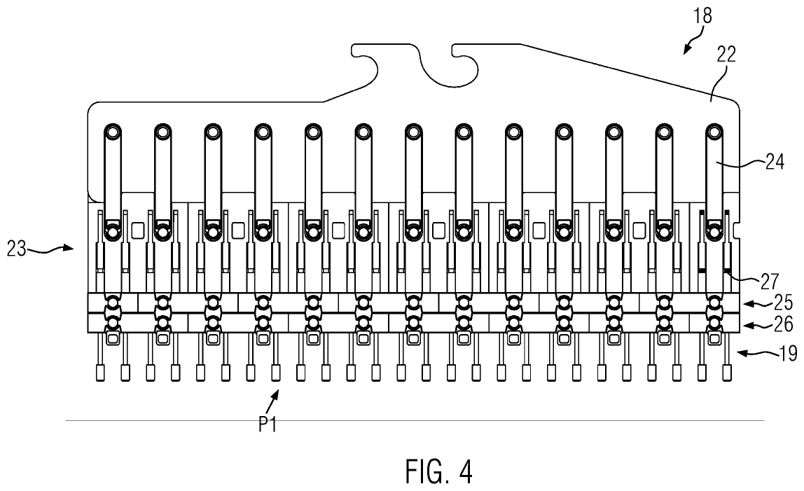

One of pusher assemblies 18 shown in FIG. 3 is shown in isolation in FIG. 4. Pusher assembly 18 is of a modular structure. Pusher assembly 18 comprises in particular a base plate 22 as well as a plurality of pin cartridges 23 attached thereto. Respective pin cartridges 23 are attached to base plate 22 by way of several coupling members 24.

In FIG. 4, six pin cartridges 23 are mounted side-by-side on base plate 22, each configured to receive four press-on pins 19. A pin cartridge 23 is attached on the outer right-hand side in the plane of the image and is only provided for receiving two press-on pins 19.

FIG. 4 also shows that pin cartridges 23 attached side-by-side on base plate 22 are held together by way of connector strips 25. Several clamping strips 26 are attached below connector strips 25 to respective pin cartridges 23 for attaching press-on pins 19 arranged thereon.

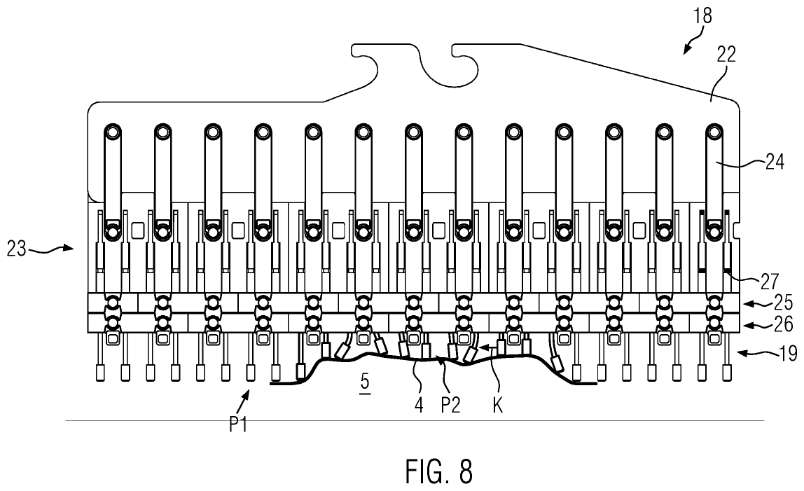

Furthermore, FIG. 4 shows that respective press-on pins 19 are preloaded by a spring 27 to extended position P1 shown in FIG. 4. When labels 8 are pressed onto top film 4, respective press-on pins 19 can be pushed into pin cartridge 23 carrying them. Press-on pins 19 pushed into pin cartridge 23 are then arranged in a retracted position P2 (see FIG. 8).

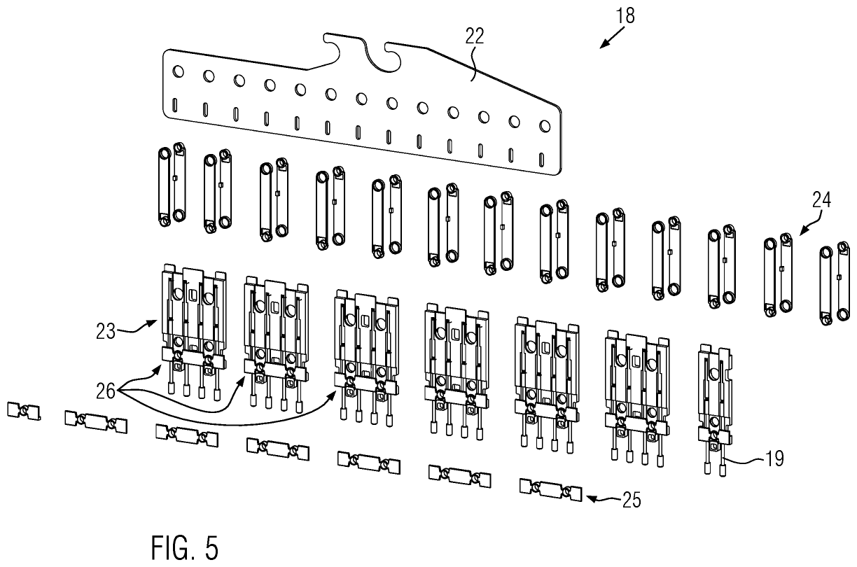

FIG. 5 shows pusher assembly 18 in an exploded view. This shows that pusher assembly 18 as a whole has a multi-part modular configuration, wherein pusher assembly 18 is composed in particular of base plate 22 and pin cartridges 23 that can be attached thereto. This results in manufacturing advantages because base plate 22 can be manufactured from different material than the respective pin cartridges. In particular, this also provides the advantage that no receptacles for the press-on pins 19 have to be manufactured in base plate 22 itself since they are received in the respective pin cartridges 23. Pin cartridges 23 can be manufactured from inexpensive material such as plastic material. This also applies to respective coupling members 24, connector strips 25 shown in isolation in FIG. 5, as well as clamping strips 26.

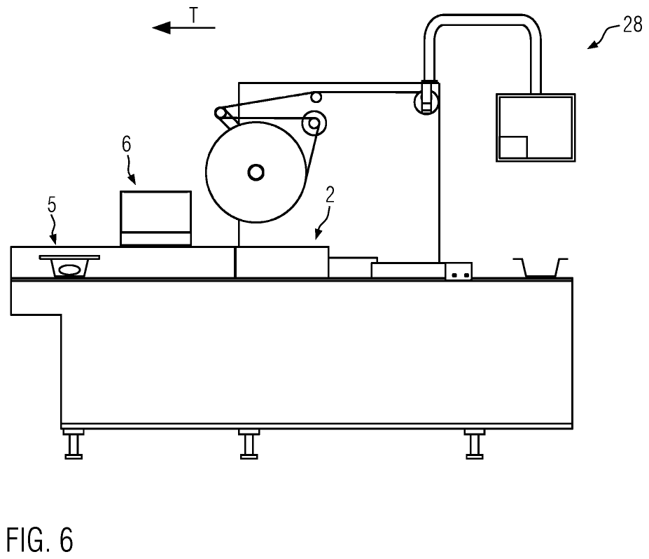

FIG. 6 shows a schematic representation of a tray sealer 28 at which labeler 6 according to the disclosure can be used. Labeler 6 at tray sealer 28 is fed individual packs 5 for the labeling process.

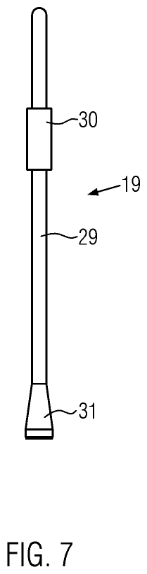

FIG. 7 shows press-on pin 19 according to the disclosure in an isolated view. Press-on pin 19 comprises a guide pin 29, at the upper end of which a peg 30 can be received by pin cartridge 23 and at the lower end of which a press member 31 is formed. Guide pin 29, peg 30, and press member 31 are manufactured integrally in an injection molding tool. Above all, it is possible for press-on pin 19 shown in FIG. 7 to be manufactured from polycaprolactam (PA6) or from nylon (PA66) in an injection molding process.

FIG. 8 shows schematically what happens when press-on pins 19 strike an uneven product or packaging surface. Press-on pins 19 bend due to the transverse forces K applied at their press members 31. The bending makes it possible for transverse forces K to be passed on to clamping strips 26 only to a very small extent, if at all. As a result, damage and/or loosening, or detachment of clamping strips 26 can be prevented. As a result, the service times of pusher assembly 18 and therefore the service times of labeler 6 at deep-drawing packaging machine 1 or at tray sealer 28 can be increased, which leads to improved productivity of the packaging machine.

What is claimed is:

1. A labeler comprising a pusher assembly for pressing labels onto an article web, the pusher assembly being mounted to be adjustable in height, wherein the pusher assembly comprises a base plate, a pin cartridge connected to the base plate, and several press-on pins that are received by the pin cartridge and that are mounted at the pin cartridge in a slidable manner to be movable between a respective extended position and a retracted position, wherein the press-on pins are each formed as an integrally manufactured injection molded part.

2. The labeler according to claim 1, wherein the press-on pins each comprise a guide pin manufactured at least in sections from a polyamide.

3. The labeler according to claim 2, wherein the polyamide comprises polycaprolactam or nylon.

4. The labeler according to claim 2, wherein each press-on pin comprises at an end of the guide pin a peg that can be received by way of the pin cartridge and a press member at the other end of the guide pin, wherein the guide pin, the peg, and the press member are manufactured integrally.

5. The labeler according to claim 4, wherein at least the guide pin of each press-on pin is reinforced with glass fibers and/or carbon fibers.

6. The labeler according to claim 1, wherein the press-on pins are manufactured entirely from a polycaprolactam or from nylon.

7. The labeler according to claim 1, wherein each press-on pin comprises a guide pin that is reinforced with glass fibers and/or carbon fibers.

8. The labeler according to claim 1, wherein each press-on pin comprises a guide pin that comprises a thermoplastic polyurethane.

9. The labeler according to claim 1, wherein the pusher assembly comprises at least one clamping strip attached to the pin cartridge for holding the press-on pins at the pin cartridge.

10. The labeler according to claim 9, wherein the at least one clamping strip is configured to absorb transverse forces that are caused during a labeling process by way of bent press-on pins and that come into contact with the at least one clamping strip.

11. The labeler according to claim 1, wherein the press-on pins each have a weight of 0.3 g to 0.5 g.

12. A press-on pin for a labeler, the press-on pin comprising a guide pin which is manufactured at least in sections from a polyamide, wherein the press-on pin is usable at a pusher assembly of the labeler for pressing labels onto an article web.

13. The press-on pin according to claim 12, wherein the polyamide comprises polycaprolactam or nylon.

14. A labeler for pressing labels onto an article web, the labeler comprising:
a pusher assembly; and
multiple press-on pins according to claim 12 attached to the pusher assembly.

15. A method of pressing a label onto an article web by a labeler including a pusher assembly having multiple press-on pins, the method comprising:
exerting pressure on the label by several of the multiple press-on pins in order to press the label onto the article web, wherein each of the multiple press-on pins comprises a guide pin that is manufactured at least in sections from a polyamide.

16. The method according to claim 15, wherein the polyamide comprises polycaprolactam or nylon.

17. The method according to claim 15, wherein each of the multiple press-on pins comprises a peg at one end of the guide pin that is received by a pin cartridge of the pusher assembly, and a press member at an opposite end of the guide pin, wherein the guide pin, the peg, and the press member are manufactured integrally.
